(19) United States
(12) Patent Application Publication
(10) Pub. No.: US 2026/0172333 A1
(43) Pub. Date: Jun. 18, 2026

(54) VARIABLE TIME TO NEXT DATA BURST INDICATION

(71) Applicant: QUALCOMM Incorporated, San Diego, CA (US)

(72) Inventors: Liangping MA, San Diego, CA (US); Sebastian SPEICHER, Wallisellen (CH); Sitaramanjaneyulu KANAMARLAPUDI, San Diego, CA (US); Imed BOUAZIZI, Celina, TX (US)

(21) Appl. No.: 18/981,574

(22) Filed: Dec. 15, 2024

(51) Int. Cl. H04L 43/087

(52) U.S. Cl. CPC H04L 43/087

(57) ABSTRACT

Methods, systems, and devices for wireless communications are described. A network entity may obtain one or more protocol data units (PDUs) of a burst of a first set of PDUs. Each PDU of the first set of PDUs may include a respective indication of a time to a next burst (TTNB) of a second set of PDUs based on a departure time of a corresponding PDU of the first set of PDUs. The network entity may monitor for a first PDU of the next burst of the second set of PDUs based on the TTNB of the second set of PDUs.

### FIELD OF TECHNOLOGY

The following relates to wireless communications, including variable time to next data burst indication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a network entity is described. The method may include obtaining one or more protocol data units (PDUs) of a burst of a first set of multiple PDUs, where each PDU of the first set of multiple PDUs includes a respective indication of a time to a next burst of a second set of multiple PDUs based on a departure time of a corresponding PDU of the first set of multiple PDUs and monitoring for a first PDU of the next burst of the second set of multiple PDUs based on the time to the next burst of the second set of multiple PDUs.

A network entity for wireless communications is described. The network entity may include one or more memories storing processor executable code, and one or more processors coupled with the one or more memories. The one or more processors may individually or collectively be operable to execute the code to cause the network entity to obtain one or more PDUs of a burst of a first set of multiple PDUs, where each PDU of the first set of multiple PDUs includes a respective indication of a time to a next burst of a second set of multiple PDUs based on a departure time of a corresponding PDU of the first set of multiple PDUs and monitor for a first PDU of the next burst of the second set of multiple PDUs based on the time to the next burst of the second set of multiple PDUs.

Another network entity for wireless communications is described. The network entity may include means for obtaining one or more PDUs of a burst of a first set of multiple PDUs, where each PDU of the first set of multiple PDUs includes a respective indication of a time to a next burst of a second set of multiple PDUs based on a departure time of a corresponding PDU of the first set of multiple PDUs and means for monitoring for a first PDU of the next burst of the second set of multiple PDUs based on the time to the next burst of the second set of multiple PDUs.

A non-transitory computer-readable medium storing code for wireless communications is described. The code may include instructions executable by one or more processors to obtain one or more PDUs of a burst of a first set of multiple PDUs, where each PDU of the first set of multiple PDUs includes a respective indication of a time to a next burst of a second set of multiple PDUs based on a departure time of a corresponding PDU of the first set of multiple PDUs and monitor for a first PDU of the next burst of the second set of multiple PDUs based on the time to the next burst of the second set of multiple PDUs.

In some examples of the method, network entities, and non-transitory computer-readable medium described herein, a first PDU of the first set of multiple PDUs includes a first indication of the time to the next burst of the second set of multiple PDUs and a second PDU of the first set of multiple PDUs includes a second indication of the time to the next burst of the second set of multiple PDUs based on the first indication of the time to the next burst and a difference in departure time between the first PDU of the first set of multiple PDUs and the second PDU of the first set of multiple PDUs.

In some examples of the method, network entities, and non-transitory computer-readable medium described herein, monitoring for the first PDU of the second set of multiple PDUs may include operations, features, means, or instructions for monitoring for the first PDU of the next burst of the second set of multiple PDUs based on a jitter associated with a network path.

Some examples of the method, network entities, and non-transitory computer-readable medium described herein may further include operations, features, means, or instructions for measuring the jitter associated with the network path based on a comparison of an indicated difference in departure time between a first PDU of the first set of multiple PDUs and a second PDU of the first set of multiple PDUs and an observed difference in departure time between the first PDU and the second PDU.

Some examples of the method, network entities, and non-transitory computer-readable medium described herein may further include operations, features, means, or instructions for measuring the jitter associated with the network path based on a first difference between a first observed delay of a first PDU of the first set of multiple PDUs and a second observed delay of a second PDU of the first set of multiple PDUs and a second difference between a first indication of the time to the next burst corresponding to the first PDU of the first set of multiple PDUs and a second indication of the time to the next burst corresponding to the second PDU of the first set of multiple PDUs.

Some examples of the method, network entities, and non-transitory computer-readable medium described herein may further include operations, features, means, or instructions for outputting the burst of the first set of multiple PDUs, where at least one PDU of the first set of multiple PDUs that may be output by the network entity includes an updated indication of the time to the next burst of the second set of multiple PDUs based on the jitter associated with the network path.

In some examples of the method, network entities, and non-transitory computer-readable medium described herein, each PDU of the first set of multiple PDUs includes a real-time transport protocol (RTP) header that includes the respective indication of the time to the next burst of the second set of multiple PDUs.

In some examples of the method, network entities, and non-transitory computer-readable medium described herein, the burst of the first set of multiple PDUs includes a first one or more protocol data units from a first Protocol Data Unit Set and a second one or more protocol data units from a second Protocol Data Unit Set.

In some examples of the method, network entities, and non-transitory computer-readable medium described herein, the network entity may be a User Plane Function (UPF).

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports variable time to next data burst indication in accordance with one or more aspects of the present disclosure.

FIG. 2 shows an example of a communications system that supports variable time to next data burst indication in accordance with one or more aspects of the present disclosure.

FIG. 3 shows an example of a process flow that supports variable time to next data burst indication in accordance with one or more aspects of the present disclosure.

FIGS. 4 and 5 show block diagrams of devices that support variable time to next data burst indication in accordance with one or more aspects of the present disclosure.

FIG. 6 shows a block diagram of a communications manager that supports variable time to next data burst indication in accordance with one or more aspects of the present disclosure.

FIG. 7 shows a diagram of a system including a device that supports variable time to next data burst indication in accordance with one or more aspects of the present disclosure.

FIGS. 8 and 9 show flowcharts illustrating methods that support variable time to next data burst indication in accordance with one or more aspects of the present disclosure.

### DETAILED DESCRIPTION

A wireless network may use bursts of protocol data units (PDUs) to communicate information over a network interface. For example, a traffic source may send a burst of PDUs to an intermediate network device, such as a router, and the router may send the burst of PDUs to a network entity, such as a user plane function (UPF). A PDU of a burst of PDUs may indicate a time to a next burst (TTNB) of PDUs. In some networks, a first PDU of the burst of PDUs may indicate the TTNB of PDUs. In some other networks, a last PDU of the burst of PDUs may indicate the TTNB of PDUs. If a first network entity is sent a first PDU burst from a second network entity, a PDU of the first PDU burst which carries the TTNB may, in some cases, be lost or otherwise not obtained at the first network entity. In this cases, the first network entity may not be able to determine when a start time of the next burst of PDUs or when the next burst of PDUs will arrive. If the first network entity is not able to determine when the next burst of PDUs will arrive, the first network entity may be in a higher power state for longer to monitor a larger window to obtain the next burst of PDUs, or the first network entity may not be monitoring during the start of the next burst of PDUs and may not obtain one or more PDUs of the next burst of PDUs.

A network described herein supports techniques for indicating a TTNB with each PDU of a PDU burst. For example, each PDU of the burst of PDUs may indicate a respective TTNB value of a next burst of PDUs that differs from a TTNB value indicated by other PDUs in the burst of PDUs. A TTNB for a specific PDU of a burst of PDUs may be based on a departure time of the PDU relative to a first PDU of the burst of PDUs. For example, a first PDU may indicate a first TTNB, and a second PDU may indicate a second TTNB, where a value of the second TTNB is based on a difference in departure time between the first PDU and the second PDU. For example, the value of the second TTNB may be lower than the value of the first TTNB based on a difference in time between a departure of the first TTNB and a departure of the second TTNB.

In some examples, the first network entity that obtains the burst of PDUs from the second network entity may determine a jitter that is introduce by the second network entity or a network interface communicated with via the second network entity. For example, the first network entity may determine a difference between an observed difference in departure time of the PDUs relative to a first PDU of a burst of PDUs and an indicated difference in departure time of the PDUs, measuring the jitter relative to the first PDUs based on the respective TTNBs of the PDUs. Additionally, or alternatively, the first network entity may measure the jitter based on differences between observed departure times between PDUs of the burst of PDUs and differences between indicated departure times between the burst of PDUs, measuring the jitter relative to a previous PDU based on the indicated TTNBs. In some examples, the first network entity may update an expected arrival time of the next burst of PDUs based on the measured jitter. Additionally, or alternatively, the first network entity may output the burst of PDUs comprising updated respective TTNB indications based on the jitter introduced by the second network entity or the network interface, or both.

Aspects of the disclosure are initially described in the context of wireless communications systems. Aspects of the disclosure are further illustrated by and described with reference to apparatus diagrams, system diagrams, and flowcharts that relate to variable time to next data burst indication.

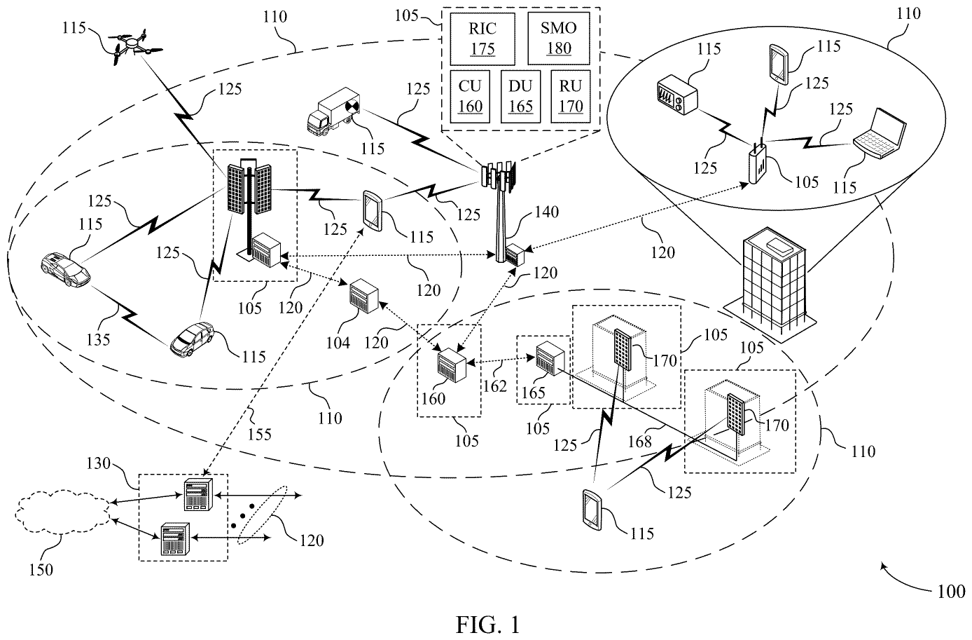

FIG. 1 shows an example of a wireless communications system 100 that supports variable time to next data burst indication in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support variable time to next data burst indication as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a UPF). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A network, such as the core network 130 of the wireless communications system 100, may use bursts of PDUs to communicate information over a network interface. For example, a traffic source may send a burst of PDUs to an intermediate network device, such as a router, and the router may send the burst of PDUs to a network entity, such as a UPF. The traffic source may be, for example, an application server. The network entity may communicate with the traffic source via a network interface, such as an N6 interface. In some examples, a burst of PDUs may be referred to as a data burst. A burst of PDUs may carry data information, such as a video frame or a video slice.

In some examples, the network entity may send the burst of PDUs to other network entities. For example, the network entity may send the burst of PDUs in a general packet radio service (GPRS) tunnelling protocol (GTP) user-plane (GTP-U) packet.

A PDU of a burst of PDUs may indicate a TTNB. In some networks, a first PDU of the burst of PDUs may indicate the TTNB. In some other networks, a last PDU of the burst of PDUs may indicate the TTNB of PDUs. If a first network entity is sent a first PDU burst from a second network entity, a PDU of the first PDU burst which carries the TTNB may, in some cases, be lost or otherwise not obtained at the first network entity. In this cases, the first network entity may not be able to determine when a start time of the next burst of PDUs or when the next burst of PDUs will arrive. If the first network entity is not able to determine when the next burst of PDUs will arrive, the first network entity may be in a higher power state for longer to monitor a larger window to obtain the next burst of PDUs, or the first network entity may not be monitoring during the start of the next burst of PDUs and may not obtain one or more PDUs of the next burst of PDUs.

A network described herein, such as the core network 130, supports techniques for indicating a TTNB of a next PDU burst with each PDU of a prior PDU burst. For example, each PDU of the prior burst of PDUs may indicate a respective TTNB for the next PDU burst. A TTNB for a specific PDU of a prior burst of PDUs may be based on a departure time of the PDU relative to a first PDU of the prior burst of PDUs. For example, a first PDU may indicate a first TTNB, and a second PDU may indicate a second TTNB, where a value of the second TTNB is based on a difference in departure time between the first PDU and the second PDU. For example, the value of the second TTNB may be lower than the value of the first TTNB based on a difference in time between a departure of the first TTNB and a departure of the second TTNB.

In some examples, the network interface used to communicate a burst of PDUs may introduce jitter or packet delay variation. For example, communication of a burst of PDUs over the network interface from the traffic source to the network entity may introduce jitter. In some examples, the burst of PDUs may be routed to the UPF from the traffic source via an intermediate network node, such as a router. The burst of PDUs being sent to the router, then the router sending the burst of PDUs to the network entity may introduce the jitter. The jitter may affect the timing of the PDUs of the burst of PDUs such that a TTNB indicated by the PDUs is inaccurate.

A network described herein may support techniques for measuring delay jitter to determine an accurate time to a next burst of PDUs. For example, a first network entity that obtains a burst of PDUs from a second network entity may determine a jitter that is introduce by the second network entity or a network interface communicated with via the second network entity. For example, the first network entity may determine a difference between an observed difference in departure time of the PDUs relative to a first PDU of a burst of PDUs and an indicated difference in departure time of the PDUs, measuring the jitter relative to the first PDUs based on the respective TTNBs of the PDUs. Additionally, or alternatively, the first network entity may measure the jitter based on differences between observed departure times between PDUs of the burst of PDUs and differences between indicated departure times between the burst of PDUs, measuring the jitter relative to a previous PDU based on the indicated TTNBs. In some examples, the first network entity may update an expected arrival time of the next burst of PDUs based on the measured jitter. Additionally, or alternatively, the first network entity may output the burst of PDUs comprising updated respective TTNB indications based on the jitter introduced by the second network entity or the network interface, or both.

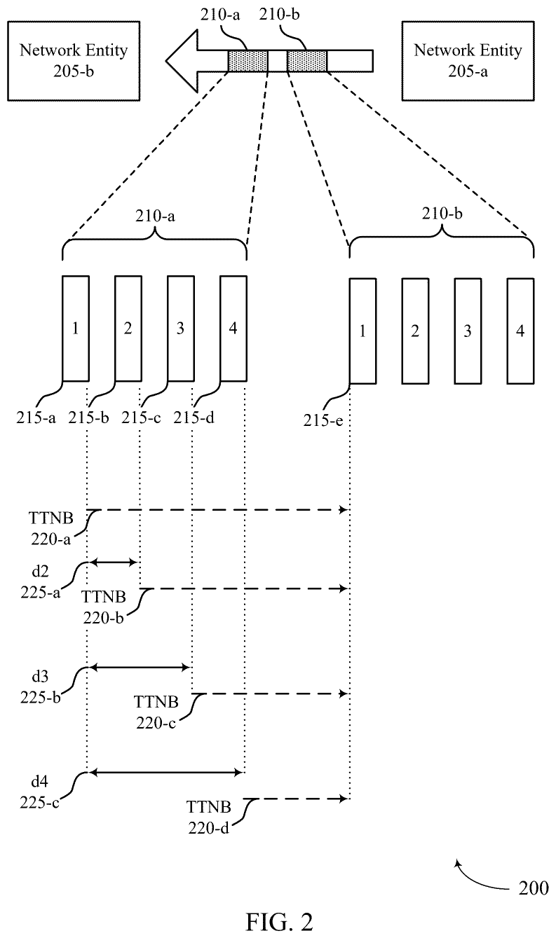

FIG. 2 shows an example of a wireless communications system 200 that supports variable time to next data burst indication in accordance with one or more aspects of the present disclosure. The wireless communications system may include a network entity 205-a and a network entity 205-b. The network entity 205-a and the network entity 205-b may each be an example of a network entity 105, a UPF, an intermediate network node, such as a router, a base station, or an entity of a core network 130 as described with reference to FIG. 1.

The network entity 205-a may send a burst 210-a of PDUs 215 and a burst 210-b of PDUs 215 to a network entity 205-b. The burst 210-a may include a first quantity of PDUs 215, and the burst 210-b may include a second quantity of PDUs 215. In the example illustrated by FIG. 2, the burst 210-a includes four PDUs 215, including a PDU 215-a, a PDU 215-b, a PDU 215-c, and a PDU 215-d. The burst 210-b may also include four PDUs 215, including a PDU 215-e, which is a first PDU 215 of the burst 210-b. In other examples, a burst 210 of PDUs 215 may include different quantities of PDUs 215.

In some examples, each PDU 215 of a burst 210 may indicate a TTNB 220. The TTNB 220, or a value of the TTNB 220, may indicate a time that will elapse between a departure of the PDU 215 indicating the TTNB 220 and a start of a next burst 210. For example, a TTNB 220-a indicated by the PDU 215-a may indicate a duration, t, between a departure time of the PDU 215-a (e.g., from the network entity 205-a) and a start of the burst 210-b, corresponding to the PDU 215-e of the burst 210-b. In some examples, the departure time may correspond to an end of a respective PDU 215, a beginning of a respective PDU 215, or intermediate time between and the beginning and end of a respective PDU 215.

A TTNB 220 indicated by another PDU 215 may be based on a departure time of the other PDU 215. For example, a TTNB 220-b may indicate a duration between a departure time of the PDU 215-b and the start of the burst 210-b. If, for example, the PDU 215-b is sent by, or departs from, the network entity 205-a after a delay 225-a, referred to as d2 in FIG. 2, from the PDU 215-a, the TTNB 220-b may indicate a duration of t−d2. For example, the TTNB 220-b may indicate a difference between the value of the TTNB 220-a and the delay between the PDU 215-a and the PDU 215-b. For example, a time to a next data burst indicated by the PDU 215 may be variable based on a departure time of the PDU 215.

The PDU 215-c may indicate a TTNB 220-c. The TTNB 220-c may correspond to a time difference between the PDU 215-c, or a departure time of the PDU 215-c, and the burst 210-b. The TTNB 220-c may be based on a difference between the duration t and a delay 225-b, referred to as d3 in FIG. 2, between departure of the first PDU 215-a and the PDU 215-c, or t−d3. Similarly, the PDU 215-d may include a TTNB 220-d, which corresponds to a time difference between a departure time of the PDU 215-d and the burst 210-b. The TTNB 220-d may be based on a difference between the duration t and d4, where d4 corresponds to a delay 225-c between a departure of the PDU 215-a and a departure of the PDU 215-d.

A TTNB 220 may correspond to, or be indicated via, a field in a header extension of a PDU 215. For example, a real-time transport protocol (RTP) header extension of the PDU 215 may include PDU set information. Additionally, or alternatively, an RTP header extension of the PDU 215 may include data burst information. The TTNB 220 may be indicated via a field of an RTP header extension used for PDU set information or data burst information, or both.

By indicating a TTNB 220 that is relative to a departure time of a PDU 215 in each PDU 215 of a burst 210, a network entity 205 receiving the burst 210 may determine a start time of a next burst by receiving any one PDU 215 of the burst 210. For example, the network entity 205-b may be able to determine a start time of the burst 210-a even if the network entity 205-b only receives one PDU 215 of the burst 210-a.

In some examples, multiple PDUs 215 may indicate a same TTNB. For example, the PDU 215-a may indicate a TTNB based on a duration between the first PDU 215-a and a start of the burst 210-b, and the PDU 215-d may indicate the TTNB that is based on the duration between the PDU 215-a and the start of the burst 210-b. In this example, the network entity 205-b may determine the start of the burst 210-b based on the TTNB indicated by the PDU 215-a, or the network entity 205-b may determine a departure time difference, or delay, between the PDU 215-a and the PDU 215-d, and the network entity 205-b may determine the start time of the burst 210-b based on the indicated TTNB and the delay between the PDU 215-a and the PDU 215-d.

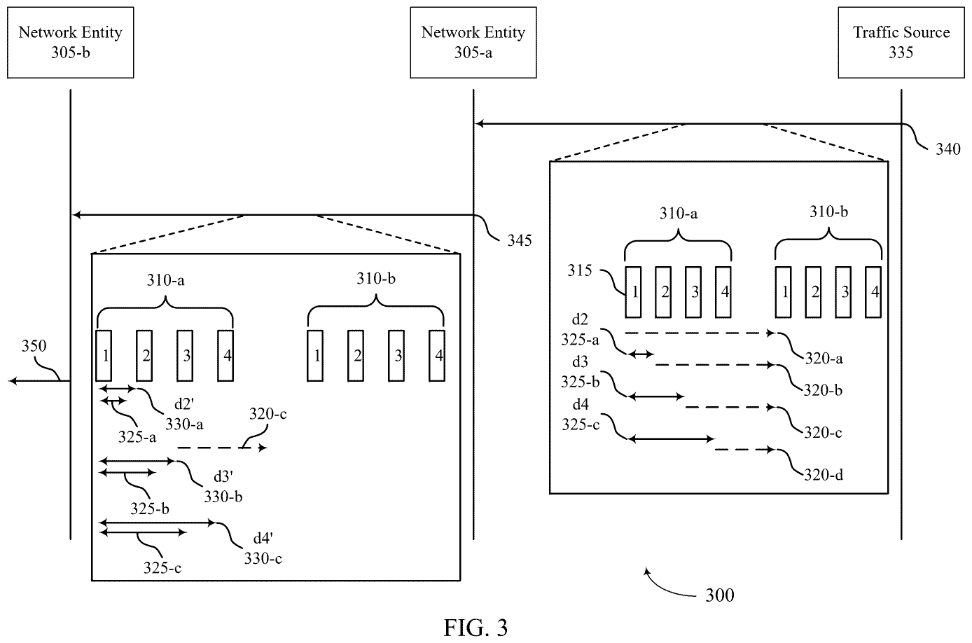

FIG. 3 shows an example of a process flow 300 that supports variable time to next data burst indication in accordance with one or more aspects of the present disclosure. The process flow 300 may implement aspects of a wireless communications system 100 or a wireless communications system 200. For example, the process flow 300 may include a network entity 305-a and a network entity 305-b, which may be examples of corresponding devices described herein. For example, the network entity 305-a may be an example of a UPF, and the network entity 305-b may be an example of a router. The process flow 300 may include a traffic source 335, which may be an example of a traffic source described herein. For example, an application server may be an example of the traffic source 335.

Alternative examples of the following may be implemented, where some steps are performed in a different order than described or are not performed at all. In some cases, steps may include additional features not mentioned below, or further steps may be added. Although the network entity 305-a, the network entity 305-b, and the traffic source 335 are shown performing the operations of the process flow 300, some aspects of some operations may also be performed by one or more other wireless devices, network entities, network devices, or network nodes.

The traffic source 335 may send (e.g., transmit, output) a burst 310-a of PDUs 315 and a burst 310-b of PDUs 315 to the network entity 305-a, and the network entity 305-a may send the burst 310-a and the burst 310-b to the network entity 305-b. For example, the traffic source 335 may route the burst 310-a and the burst 310-b to the network entity 305-b via the network entity 305-a over a network interface, such as an N6 interface. In some examples, a burst 310 may include Protocol Data Units from one or more Protocol Data Unit sets. For example, the PDUs 315 of a burst 310 may correspond to different Protocol Data Unit sets. A Protocol Data Unit set may correspond to at least some common parameters, such as Quality of Service parameters, a delay budget, and error rate, or integrated handling information.

Multiple PDUs 315 of a burst 310 may indicate a TTNB 320 as described herein. A TTNB 320 may indicate a time that will elapse between a departure of a PDU 315, which includes or indicates the TTNB 320, and a start of a next burst 310. For example, a TTNB 320-a indicated by a first PDU of the burst 310-a, shown as PDU 1 in FIG. 3, sent from the traffic source 335 to the network entity 305-a may indicate a duration, t, between a departure time of the first PDU and a start of the burst 310-b, corresponding to a first PDU 315 of the burst 310-b.

As described with reference to FIG. 2, in some examples, each PDU 315 of a burst 310 may indicate a TTNB that is relative to a delay or difference in departure time from a first PDU 315 of the burst 310. For example, a second PDU of the burst 310-a may indicate a TTNB 320-b based on a delay 325-a between a departure time of the second PDU and a departure time of the first PDU. A third PDU of the burst 310-a may indicate a TTNB 320-c based on a delay 325-b between a departure time of the third PDU and a departure time of the first PDU. A fourth PDU of the burst 310-a may indicate a TTNB 320-d based on a delay 325-c between a departure time of the fourth PDU and a departure time of the first PDU. A TTNB 320 may be indicated by a PDU 315 via a header or a header extension of the PDU 315.

The network entity 305-a may send the burst 310-a and the burst 310-b to the network entity 305-b. In some examples, the PDUs 315 of the burst 310-a and the burst 310-b may include the same TTNB fields as received by the burst 310-a and the burst 310-b received from the traffic source 335. For example, the network entity 305-a may forward or route the burst 310-a and the burst 310-b to the network entity 305-b containing the same information.

In some examples, a network interface or an intermediate network node may introduce jitter or packet delay variation. For example, a path from the traffic source 335 to the network entity 305-b, or the network interface, may introduce packet delay variation between different PDUs 315 of a burst 310-a. Packet delays may change after the PDUs 315 pass a network. For example, after passing through a slower-speed router, time gaps between adjacent PDUs 315 may increase. For example, the network entity 305-a routing the bursts 310 to the network entity 305-b may introduce the packet delay variation, such as if the network entity 305-a is a slower-speed router.

For example, the network entity 305-a may send the burst 310-a and the burst 310-b to the network entity 305-b. However, a delay between PDUs 315 of the bursts 310 when sent from the network entity 305-a to the network entity 305-b may be increased compared to a delay between the PDUs 315 to the bursts 310 when sent from the traffic source 335 to the network entity 305-a.

If packet delay variation or jitter is introduced, the TTNB fields of the PDUs 315 of a burst 310 may not accurately indicate a start time of a next burst. For example, the TTNBs indicated by the PDUs of the burst 310-a sent from the network entity 305-a to the network entity 305-b may not accurately indicate a start time of the burst 310-b, as the packet delay variation may have changed the timing of the PDUs 315 or the burst 310-b, or both. The packet delay variation of a PDU 315, or the packet delay variation accumulated across multiple PDUs 315, may change the start time of the burst 310-b. For example, the TTNB 320-c, indicated by a third PDU 315 of burst 310-a sent from the network entity 305-a to the network entity 305-b, may not accurately align with a starting arrival time of the burst 310-b at the network entity 305-b, as illustrated in FIG. 3.

The network entity 305-b may implement techniques to measure the jitter or the packet delay variation based on the TTNBs 320 indicated by the PDUs of a burst 310. For example, the network entity 305-b may measure or derive the packet delay variation based on a delay 325-a, corresponding to differences between values of the TTNBs 320 of the PDUs 315, and an observed delay 330, corresponding to differences between when the PDUs 315 are obtained by the network entity 305-b. The network entity 305-b may perform a jitter measurement using multiple TTNB values.

In some examples, the network entity 305-b may measure the jitter based on delay variations relative to a first PDU 315 of a burst 310. For example, the network entity 305-b may measure a one-way delay variation relative to the first PDU 315 of a burst 310. A first PDU 315 may indicate the TTNB 320-a, and a second PDU 315 of the burst 310-a may indicate the TTNB 320-b. The network entity 305-b may determine the delay 325-a (e.g., d2) based on a difference between the TTNB 320-b and the TTNB 320-a. The network entity 305-b may determine an observed delay 330-a between an arrival time of the first PDU and the second PDU of the burst 310-a. The network entity 305-a may measure a jitter or packet delay variation, introduced by the network interface or by the network entity 305-a, based on a difference between the delay 325-a, corresponding to or indicated by the TTNB 320-a, and the observed delay 330-a. The network entity 305-a may additionally, or alternatively, measure the jitter or packet delay variation based on other PDUs 315 of the burst 310-a. For example, the network entity 305-a may measure the packet delay variation based on a difference between an observed delay 330-b for the third packet and the delay 325-b, corresponding to the TTNB 320-c, or based on a difference between an observed delay 330-c and the delay 325-c, corresponding to the TTNB 320-d. In some examples, the network entity 305-b may measure the jitter based on

delay variations relative to a previous PDU 315 of a burst 310. For example, the network entity 305-b may determine the delay 325-a for the second PDU of the burst 310-a based on the TTNB 320-b and measure the observed delay 330-a for the second PDU of the burst 310-a. The network entity 305-b may determine the delay 325-b for the third PDU of the burst 310-a based on the TTNB 320-c and measure the observed delay 330-b for the third PDU of the burst 310-a. The network entity 305-b may determine a difference between the indicated inter-PDU delay and the observed inter-PDU delay. For example, the network entity 305-b may determine a first difference between the observed delay 330-b and the observed delay 330-a, d3′−d2′, and the network entity may determine a second difference between the delay 325-a and the delay 325-b, d3−d2. The network entity 305-b may measure the jitter or packet delay variation based on a difference between the first difference and the second difference, or (d3′−d2′)−(d3−d2). Additionally, or alternatively, the network entity 305-b may measure the jitter or packet delay variation based on differences between observed delays 330 and differences between indicated delays (e.g., delays 325) of other packets.

In some examples, the network entity 305-b may adjust a predicted starting time of the next burst, or a predicted departure time of a first PDU 315 of burst 310-b, based on a measurement of the jitter or the packet delay variation. For example, the network entity 305-b may accumulate the packet delay variation that is introduced for each PDU 315 of the burst 310-a to determine an updated or adjusted start time, or arrival time, of the burst 310-b at the network entity 305-b. In some examples, if the predicted starting time is continuously updated as the PDUs 315 of a current data burst depart, a derivation of the delay jitter may be less accurate.

In some examples, the network entity 305-b may adjust a TTNB 320 based on the measured jitter and the indicated TTNB values. For example, the network entity 305-b may output the burst 310-a and the burst 310-b to another network entity or network node, and the network entity 305-b may include updated TTNBs in the PDUs of the burst 310-a and the burst 310-b based on the TTNBs 320 and the measured jitter. For example, the network entity 305-b may include the updated TTNB values in headers of respective GTP-U packets encapsulating incoming PDUs when outputting the PDUs 315 of the bursts 310 as GTP-U packets.

In an example, a network entity 305, such as the network entity 305-b, may obtain one or more PDUs 315 of a burst 310 of a first set of PDUs 315. Each PDU 315 of the first set of PDUs 315 may include a respective indication of a TTNB 320 to a next burst 310 of a second set of PDUs 315 based on a departure time of a corresponding PDU 315 of the first set of PDUs 315. For example, the network entity 305-b may receive a burst 310-a of PDUs 315 from the network entity 305-a. Each PDU 315 of the burst 310-a may include a respective TTNB 320 to a burst 310-b, where each TTNB 320 may be based on a respective departure time from the network entity 305-a. For example, a first PDU of the burst 310-a may indicate the TTNB 320-a, a second PDU of the burst 310-a may indicate the TTNB 320-b, a third PDU of the burst 310-a may indicate the TTNB 320-c, and a fourth PDU of the burst 310-a may indicate the TTNB 320-d.

The network entity 305-b may monitor for a first PDU 315 of the next burst 310 of the second set of PDUs 315 based on the TTNB 320 of the second set of PDUs 315. For example, the network entity 305-b may monitor for a first PDU of the burst 310-b of the second set of PDUs based on the TTNBs 320 indicated by the first set of PDUs 315 in the burst 310-a.

In some examples, the network entity 305-b may monitor for the first PDU 315 of the next burst based on a jitter associated with a network path. For example, the network entity 305-b may monitor for the first PDU 315 of the burst 310-b based on a jitter associated with an N6 network path, such as a jitter which is introduced by a network path between the traffic source 335 and the network entity 305-b.

In some examples, the network entity 305-b may measure the jitter associated with the network path based on delay variation relative to a first PDU of a burst 310. For example, the network entity 305-b may measure a one-way delay variation relative to a first PDU. For example, the network entity 305-b may measure the jitter based on a comparison of an indicated difference in departure time between a first PDU 315 of the first set of PDUs 315 and a second PDU 315 of the first set of PDUs 315 and an observed difference in departure time between the first PDU 315 and the second PDU 315. For example, for the second PDU 315 of the burst 310-a, the network entity 305-b may determine d2′−d2.

In some examples, the network entity 305-b may measure the jitter associated with the network path based on an inter-PDU or inter-packet delay variation. The network entity 305-b may measure a one-way delay variation relative to the previous PDU, or using inter-packet delay. For example, the network entity 305-b may measure the jitter based on a first difference between a first observed delay of a first PDU of the first set of PDUS 315 and a second observed delay of a second PDU 315 of the first set of PDUs 315 and a second difference between a first indication of the TTNB corresponding to the first PDU 315 of the first set of PDUs 315 and a second indication of the TTNB corresponding to the second PDU of the first set of PDUs. For example, example, the network entity 305-b may determine a difference between an observed delay 330-a for the second PDU 315 of the burst 310-a and an observed delay 330-b for the third PDU 315 of the burst 310-a, corresponding to d 3′−d2′, and the network entity 305-b may determine a difference between the TTNB 320-b and the TTNB 320-c, corresponding to d3−d2. The network entity 305-b may measure the jitter based on a difference between the variations, or (d3′−d2′)−(d3−d2).

In some examples, the network entity 305-b may output the burst 310-a of the first set of PDU 315. In some examples, at least one PDU 315 of the first set of PDUs 315 that is output by the network entity 305-b may include an updated indication of the time to the next burst 310 of the second set of PDUs 315 based on the jitter associated with the network path. For example, the network entity 305-b may include an updated TTNB in at least one PDU 315 of the first set of PDUs 315 based on an updated estimate of a start time of the burst 310-b based on the measurement of the jitter.

The traffic source 335 may send the burst 310-a and the burst 310-b to the network entity 305-a at 340. Multiple PDUs in each of burst 310-a and the burst 310-b may include the TTNBs 320 as described herein, and the network entity 305-a may monitor for a next burst based on the TTNBs. The network entity 305-b may send the burst 310-a and the burst 310-b to the network entity 305-b at 345. The multiple PDUs in each of the burst 310-a and the burst 310-b may include the TTNBs 320 as described herein. The network entity 305-b may output the burst 310-a or the burst 310-a and the burst 310-b at 350. The burst 310-a or the burst 310-b, or both, may include the TTNBs 320 as described herein or updated TTNBs based on a jitter measurement as described herein.

While the jitter measurement techniques are generally described with reference to the network entity 305-b, the network entity 305-a may, in some examples, perform jitter measurements and include updated TTNBs when sending the burst 310-a and the burst 310-b. Additionally, or alternatively, other network devices may perform the jitter measurements and update a TTNB 320 based on these techniques.

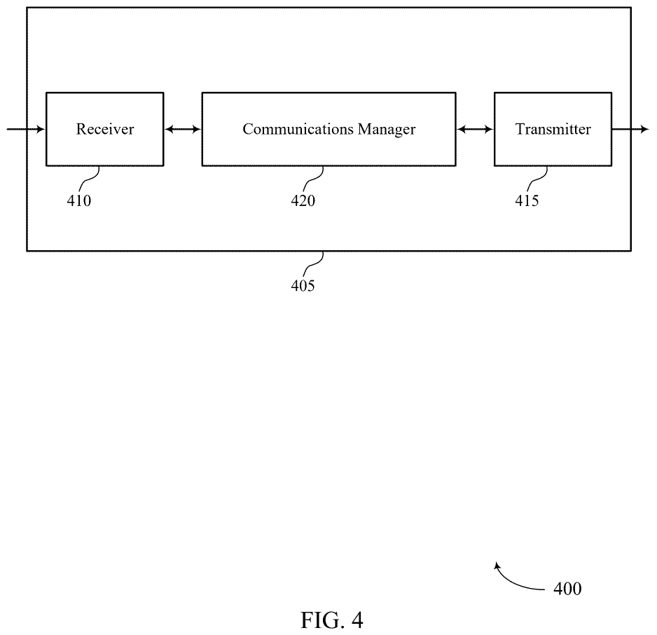

FIG. 4 shows a block diagram 400 of a device 405 that supports variable time to next data burst indication in accordance with one or more aspects of the present disclosure. The device 405 may be an example of aspects of a network entity 105 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 405. In some examples, the receiver 410 may support obtaining information by receiving signals via one or more antennas. Additionally, or alternatively, the receiver 410 may support obtaining information by receiving signals via one or more wired (e.g., electrical, fiber optic) interfaces, wireless interfaces, or any combination thereof.

The transmitter 415 may provide a means for outputting (e.g., transmitting, providing, conveying, sending) information generated by other components of the device 405. For example, the transmitter 415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 415 may support outputting information by transmitting signals via one or more antennas. Additionally, or alternatively, the transmitter 415 may support outputting information by transmitting signals via one or more wired (e.g., electrical, fiber optic) interfaces, wireless interfaces, or any combination thereof. In some examples, the transmitter 415 and the receiver 410 may be co-located in a transceiver, which may include or be coupled with a modem.

The communications manager 420, the receiver 410, the transmitter 415, or various combinations or components thereof may be examples of means for performing various aspects of variable time to next data burst indication as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for obtaining one or more PDUs of a burst of a first set of multiple PDUs, where each PDU of the first set of multiple PDUs includes a respective indication of a time to a next burst of a second set of multiple PDUs based on a departure time of a corresponding PDU of the first set of multiple PDUs. The communications manager 420 is capable of, configured to, or operable to support a means for monitoring for a first PDU of the next burst of the second set of multiple PDUs based on the time to the next burst of the second set of multiple PDUs.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing and reduced power consumption.

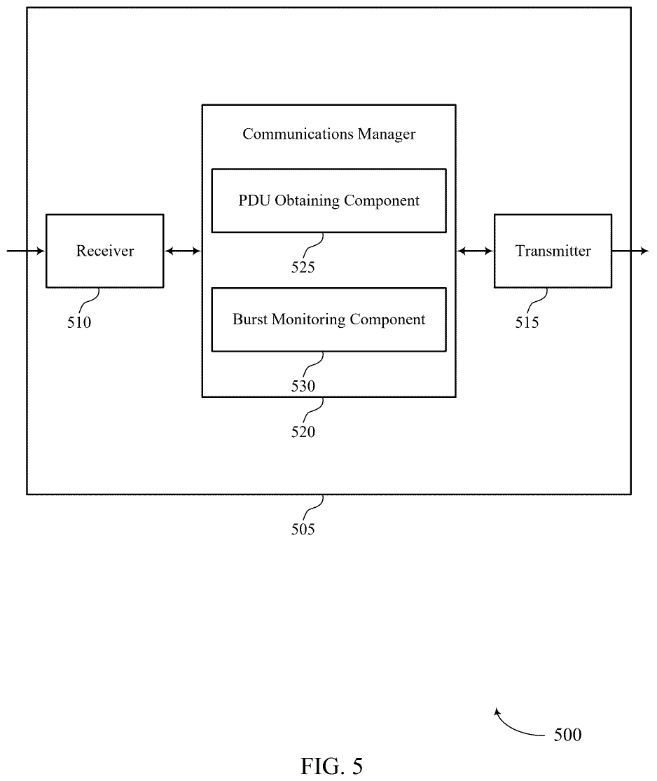

FIG. 5 shows a block diagram 500 of a device 505 that supports variable time to next data burst indication in accordance with one or more aspects of the present disclosure. The device 505 may be an example of aspects of a device 405 or a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The device 505, or various components thereof, may be an example of means for performing various aspects of variable time to next data burst indication as described herein. For example, the communications manager 520 may include a PDU obtaining component 525 a burst monitoring component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The PDU obtaining component 525 is capable of, configured to, or operable to support a means for obtaining one or more PDUs of a burst of a first set of multiple PDUs, where each PDU of the first set of multiple PDUs includes a respective indication of a time to a next burst of a second set of multiple PDUs based on a departure time of a corresponding PDU of the first set of multiple PDUs. The burst monitoring component 530 is capable of, configured to, or operable to support a means for monitoring for a first PDU of the next burst of the second set of multiple PDUs based on the time to the next burst of the second set of multiple PDUs.

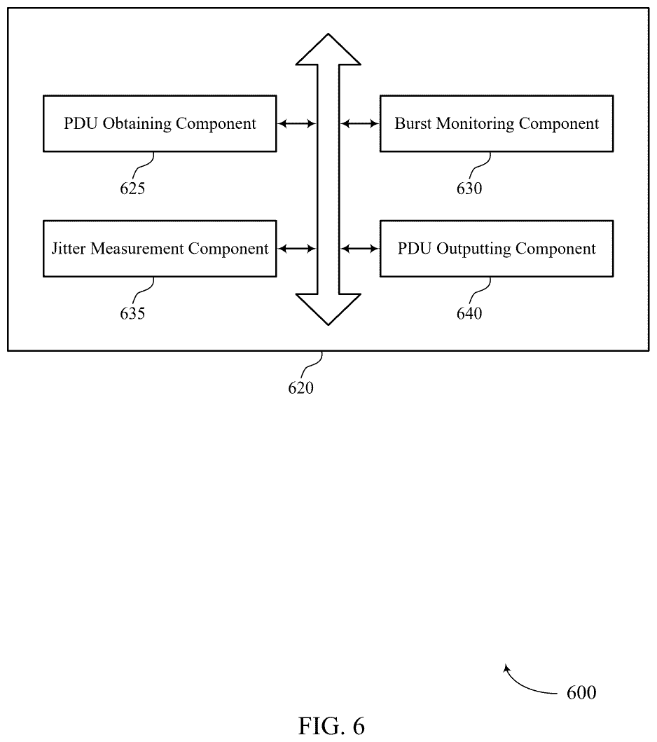

FIG. 6 shows a block diagram 600 of a communications manager 620 that supports variable time to next data burst indication in accordance with one or more aspects of the present disclosure. The communications manager 620 may be an example of aspects of a communications manager 420, a communications manager 520, or both, as described herein. The communications manager 620, or various components thereof, may be an example of means for performing various aspects of variable time to next data burst indication as described herein. For example, the communications manager 620 may include a PDU obtaining component 625, a burst monitoring component 630, a jitter measurement component 635, a PDU outputting component 640, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 620 may support wireless communications in accordance with examples as disclosed herein. The PDU obtaining component 625 is capable of, configured to, or operable to support a means for obtaining one or more PDUs of a burst of a first set of multiple PDUs, where each PDU of the first set of multiple PDUs includes a respective indication of a time to a next burst of a second set of multiple PDUs based on a departure time of a corresponding PDU of the first set of multiple PDUs. The burst monitoring component 630 is capable of, configured to, or operable to support a means for monitoring for a first PDU of the next burst of the second set of multiple PDUs based on the time to the next burst of the second set of multiple PDUs.

In some examples, a first PDU of the first set of multiple PDUs includes a first indication of the time to the next burst of the second set of multiple PDUs. In some examples, a second PDU of the first set of multiple PDUs includes a second indication of the time to the next burst of the second set of multiple PDUs based on the first indication of the time to the next burst and a difference in departure time between the first PDU of the first set of multiple PDUs and the second PDU of the first set of multiple PDUs.

In some examples, to support monitoring for the first PDU of the second set of multiple PDUs, the burst monitoring component 630 is capable of, configured to, or operable to support a means for monitoring for the first PDU of the next burst of the second set of multiple PDUs based on a jitter associated with a network path.

In some examples, the jitter measurement component 635 is capable of, configured to, or operable to support a means for measuring the jitter associated with the network path based on a comparison of an indicated difference in departure time between a first PDU of the first set of multiple PDUs and a second PDU of the first set of multiple PDUs and an observed difference in departure time between the first PDU and the second PDU.

In some examples, the jitter measurement component 635 is capable of, configured to, or operable to support a means for measuring the jitter associated with the network path based on a first difference between a first observed delay of a first PDU of the first set of multiple PDUs and a second observed delay of a second PDU of the first set of multiple PDUs and a second difference between a first indication of the time to the next burst corresponding to the first PDU of the first set of multiple PDUs and a second indication of the time to the next burst corresponding to the second PDU of the first set of multiple PDUs.

In some examples, the PDU outputting component 640 is capable of, configured to, or operable to support a means for outputting the burst of the first set of multiple PDUs, where at least one PDU of the first set of multiple PDUs that is output by the network entity includes an updated indication of the time to the next burst of the second set of multiple PDUs based on the jitter associated with the network path.

In some examples, each PDU of the first set of multiple PDUs includes a real-time transport protocol (RTP) header that includes the respective indication of the time to the next burst of the second set of multiple PDUs.

In some examples, the burst of the first set of multiple PDUs includes a first one or more protocol data units from a first Protocol Data Unit Set and a second one or more protocol data units from a second Protocol Data Unit Set.

In some examples, the network entity is a UPF.

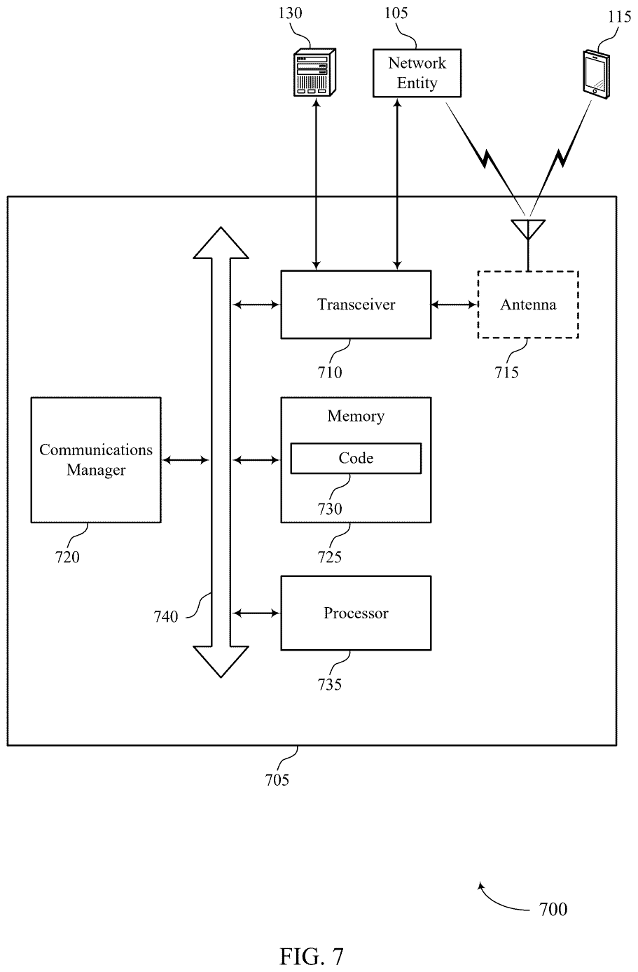

FIG. 7 shows a diagram of a system 700 including a device 705 that supports variable time to next data burst indication in accordance with one or more aspects of the present disclosure. The device 705 may be an example of or include components of a device 405, a device 505, or a network entity 105 as described herein. The device 705 may communicate with other network devices or network equipment such as one or more of the network entities 105, UEs 115, or any combination thereof. The communications may include communications over one or more wired interfaces, over one or more wireless interfaces, or any combination thereof. The device 705 may include components that support outputting and obtaining communications, such as a communications manager 720, a transceiver 710, one or more antennas 715, at least one memory 725, code 730, and at least one processor 735. These components may be in electronic communication or otherwise coupled (e.g., operatively, communicatively, functionally, electronically, electrically) via one or more buses (e.g., a bus 740).

The transceiver 710 may support bi-directional communications via wired links, wireless links, or both as described herein. In some examples, the transceiver 710 may include a wired transceiver and may communicate bi-directionally with another wired transceiver. Additionally, or alternatively, in some examples, the transceiver 710 may include a wireless transceiver and may communicate bi-directionally with another wireless transceiver. In some examples, the device 705 may include one or more antennas 715, which may be capable of transmitting or receiving wireless transmissions (e.g., concurrently). The transceiver 710 may also include a modem to modulate signals, to provide the modulated signals for transmission (e.g., by one or more antennas 715, by a wired transmitter), to receive modulated signals (e.g., from one or more antennas 715, from a wired receiver), and to demodulate signals. In some implementations, the transceiver 710 may include one or more interfaces, such as one or more interfaces coupled with the one or more antennas 715 that are configured to support various receiving or obtaining operations, or one or more interfaces coupled with the one or more antennas 715 that are configured to support various transmitting or outputting operations, or a combination thereof. In some implementations, the transceiver 710 may include or be configured for coupling with one or more processors or one or more memory components that are operable to perform or support operations based on received or obtained information or signals, or to generate information or other signals for transmission or other outputting, or any combination thereof. In some implementations, the transceiver 710, or the transceiver 710 and the one or more antennas 715, or the transceiver 710 and the one or more antennas 715 and one or more processors or one or more memory components (e.g., the at least one processor 735, the at least one memory 725, or both), may be included in a chip or chip assembly that is installed in the device 705. In some examples, the transceiver 710 may be operable to support communications via one or more communications links (e.g., communication link(s) 125, backhaul communication link(s) 120, a midhaul communication link 162, a fronthaul communication link 168).

The at least one memory 725 may include RAM, ROM, or any combination thereof. The at least one memory 725 may store computer-readable, computer-executable, or processor-executable code, such as the code 730. The code 730 may include instructions that, when executed by one or more of the at least one processor 735, cause the device 705 to perform various functions described herein. The code 730 may be stored in a non-transitory computer-readable medium such as system memory or another type of memory. In some cases, the code 730 may not be directly executable by a processor of the at least one processor 735 but may cause a computer (e.g., when compiled and executed) to perform functions described herein. In some cases, the at least one memory 725 may include, among other things, a BIOS which may control basic hardware or software operation such as the interaction with peripheral components or devices. In some examples, the at least one processor 735 may include multiple processors and the at least one memory 725 may include multiple memories. One or more of the multiple processors may be coupled with one or more of the multiple memories which may, individually or collectively, be configured to perform various functions herein (for example, as part of a processing system).

The at least one processor 735 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 735 may be configured to operate a memory array using a memory controller. In some other cases, a memory controller may be integrated into one or more of the at least one processor 735. The at least one processor 735 may be configured to execute computer-readable instructions stored in a memory (e.g., one or more of the at least one memory 725) to cause the device 705 to perform various functions (e.g., functions or tasks supporting variable time to next data burst indication). For example, the device 705 or a component of the device 705 may include at least one processor 735 and at least one memory 725 coupled with one or more of the at least one processor 735, the at least one processor 735 and the at least one memory 725 configured to perform various functions described herein. The at least one processor 735 may be an example of a cloud-computing platform (e.g., one or more physical nodes and supporting software such as operating systems, virtual machines, or container instances) that may host the functions (e.g., by executing code 730) to perform the functions of the device 705. The at least one processor 735 may be any one or more suitable processors capable of executing scripts or instructions of one or more software programs stored in the device 705 (such as within one or more of the at least one memory 725).

In some examples, the at least one processor 735 may include multiple processors and the at least one memory 725 may include multiple memories. One or more of the multiple processors may be coupled with one or more of the multiple memories, which may, individually or collectively, be configured to perform various functions herein. In some examples, the at least one processor 735 may be a component of a processing system, which may refer to a system (such as a series) of machines, circuitry (including, for example, one or both of processor circuitry (which may include the at least one processor 735) and memory circuitry (which may include the at least one memory 725)), or components, that receives or obtains inputs and processes the inputs to produce, generate, or obtain a set of outputs. The processing system may be configured to perform one or more of the functions described herein. For example, the at least one processor 735 or a processing system including the at least one processor 735 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 725 or otherwise, to perform one or more of the functions described herein.

In some examples, a bus 740 may support communications of (e.g., within) a protocol layer of a protocol stack. In some examples, a bus 740 may support communications associated with a logical channel of a protocol stack (e.g., between protocol layers of a protocol stack), which may include communications performed within a component of the device 705, or between different components of the device 705 that may be co-located or located in different locations (e.g., where the device 705 may refer to a system in which one or more of the communications manager 720, the transceiver 710, the at least one memory 725, the code 730, and the at least one processor 735 may be located in one of the different components or divided between different components).

In some examples, the communications manager 720 may manage aspects of communications with a core network 130 (e.g., via one or more wired or wireless backhaul links). For example, the communications manager 720 may manage the transfer of data communications for client devices, such as one or more UEs 115. In some examples, the communications manager 720 may manage communications with one or more other network entities 105, and may include a controller or scheduler for controlling communications with UEs 115 (e.g., in cooperation with the one or more other network devices). In some examples, the communications manager 720 may support an X2 interface within an LTE/LTE-A wireless communications network technology to provide communication between network entities 105.

The communications manager 720 may support wireless communications in accordance with examples as disclosed herein. For example, the communications manager 720 is capable of, configured to, or operable to support a means for obtaining one or more PDUs of a burst of a first set of multiple PDUs, where each PDU of the first set of multiple PDUs includes a respective indication of a time to a next burst of a second set of multiple PDUs based on a departure time of a corresponding PDU of the first set of multiple PDUs. The communications manager 720 is capable of, configured to, or operable to support a means for monitoring for a first PDU of the next burst of the second set of multiple PDUs based on the time to the next burst of the second set of multiple PDUs.

By including or configuring the communications manager 720 in accordance with examples as described herein, the device 705 may support techniques for improved communication reliability, reduced power consumption, and improved coordination between devices.

In some examples, the communications manager 720 may be configured to perform various operations (e.g., receiving, obtaining, monitoring, outputting, transmitting) using or otherwise in cooperation with the transceiver 710, the one or more antennas 715 (e.g., where applicable), or any combination thereof. Although the communications manager 720 is illustrated as a separate component, in some examples, one or more functions described with reference to the communications manager 720 may be supported by or performed by the transceiver 710, one or more of the at least one processor 735, one or more of the at least one memory 725, the code 730, or any combination thereof (for example, by a processing system including at least a portion of the at least one processor 735, the at least one memory 725, the code 730, or any combination thereof). For example, the code 730 may include instructions executable by one or more of the at least one processor 735 to cause the device 705 to perform various aspects of variable time to next data burst indication as described herein, or the at least one processor 735 and the at least one memory 725 may be otherwise configured to, individually or collectively, perform or support such operations.

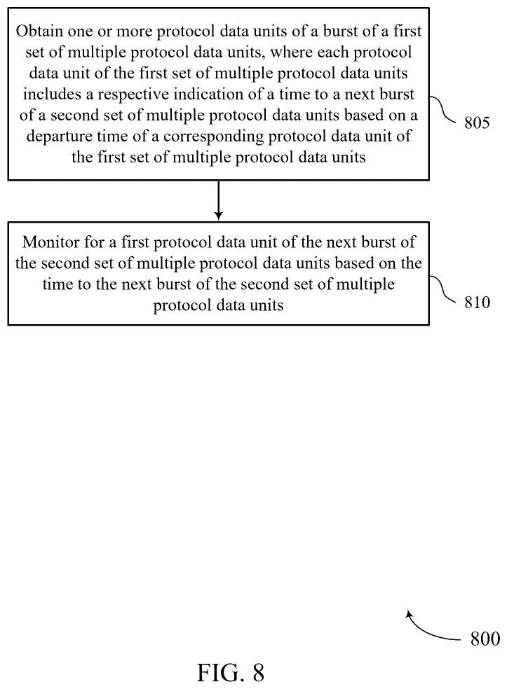

FIG. 8 shows a flowchart illustrating a method 800 that supports variable time to next data burst indication in accordance with one or more aspects of the present disclosure. The operations of the method 800 may be implemented by a network entity or its components as described herein. For example, the operations of the method 800 may be performed by a network entity as described with reference to FIGS. 1 through 7. In some examples, a network entity may execute a set of instructions to control the functional elements of the network entity to perform the described functions. Additionally, or alternatively, the network entity may perform aspects of the described functions using special-purpose hardware.

At 805, the method may include obtaining one or more PDUs of a burst of a first set of multiple PDUs, where each PDU of the first set of multiple PDUs includes a respective indication of a time to a next burst of a second set of multiple PDUs based on a departure time of a corresponding PDU of the first set of multiple PDUs. The operations of 805 may be performed in accordance with examples as disclosed herein. In some examples, aspects of the operations of 805 may be performed by a PDU obtaining component 625 as described with reference to FIG. 6.

At 810, the method may include monitoring for a first PDU of the next burst of the second set of multiple PDUs based on the time to the next burst of the second set of multiple PDUs. The operations of 810 may be performed in accordance with examples as disclosed herein. In some examples, aspects of the operations of 810 may be performed by a burst monitoring component 630 as described with reference to FIG. 6.

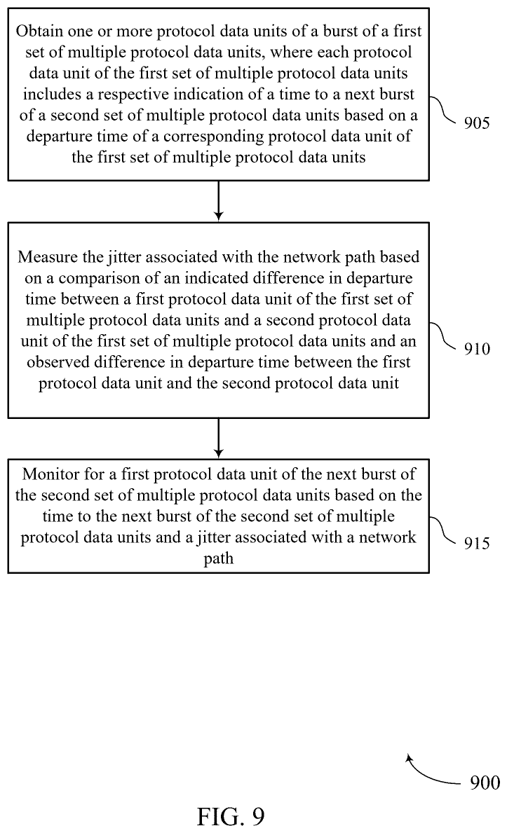

FIG. 9 shows a flowchart illustrating a method 900 that supports variable time to next data burst indication in accordance with one or more aspects of the present disclosure. The operations of the method 900 may be implemented by a network entity or its components as described herein. For example, the operations of the method 900 may be performed by a network entity as described with reference to FIGS. 1 through 7. In some examples, a network entity may execute a set of instructions to control the functional elements of the network entity to perform the described functions. Additionally, or alternatively, the network entity may perform aspects of the described functions using special-purpose hardware.

At 905, the method may include obtaining one or more PDUs of a burst of a first set of multiple PDUs, where each PDU of the first set of multiple PDUs includes a respective indication of a time to a next burst of a second set of multiple PDUs based on a departure time of a corresponding PDU of the first set of multiple PDUs. The operations of 905 may be performed in accordance with examples as disclosed herein. In some examples, aspects of the operations of 905 may be performed by a PDU obtaining component 625 as described with reference to FIG. 6.

At 910, the method may include measuring the jitter associated with the network path based on a comparison of an indicated difference in departure time between a first PDU of the first set of multiple PDUs and a second PDU of the first set of multiple PDUs and an observed difference in departure time between the first PDU and the second PDU. The operations of 910 may be performed in accordance with examples as disclosed herein. In some examples, aspects of the operations of 910 may be performed by a jitter measurement component 635 as described with reference to FIG. 6.

At 915, the method may include monitoring for a first PDU of the next burst of the second set of multiple PDUs based on the time to the next burst of the second set of multiple PDUs and a jitter associated with a network path. The operations of 915 may be performed in accordance with examples as disclosed herein. In some examples, aspects of the operations of 915 may be performed by a burst monitoring component 630 as described with reference to FIG. 6.

The following provides an overview of aspects of the present disclosure:

Aspect 1: A method for wireless communications at a network entity, comprising: obtaining one or more protocol data units of a burst of a first plurality of protocol data units, wherein each protocol data unit of the first plurality of protocol data units comprises a respective indication of a time to a next burst of a second plurality of protocol data units based at least in part on a departure time of a corresponding protocol data unit of the first plurality of protocol data units; and monitoring for a first protocol data unit of the next burst of the second plurality of protocol data units based at least in part on the time to the next burst of the second plurality of protocol data units.

Aspect 2: The method of aspect 1, wherein a first protocol data unit of the first plurality of protocol data units comprises a first indication of the time to the next burst of the second plurality of protocol data units; and a second protocol data unit of the first plurality of protocol data units comprises a second indication of the time to the next burst of the second plurality of protocol data units based at least in part on the first indication of the time to the next burst and a difference in departure time between the first protocol data unit of the first plurality of protocol data units and the second protocol data unit of the first plurality of protocol data units.

Aspect 3: The method of any of aspects 1 through 2, wherein monitoring for the first protocol data unit of the second plurality of protocol data units comprises: monitoring for the first protocol data unit of the next burst of the second plurality of protocol data units based at least in part on a jitter associated with a network path.

Aspect 4: The method of aspect 3, further comprising: measuring the jitter associated with the network path based at least in part on a comparison of an indicated difference in departure time between a first protocol data unit of the first plurality of protocol data units and a second protocol data unit of the first plurality of protocol data units and an observed difference in departure time between the first protocol data unit and the second protocol data unit.

Aspect 5: The method of any of aspects 3 through 4, further comprising: measuring the jitter associated with the network path based at least in part on a first difference between a first observed delay of a first protocol data unit of the first plurality of protocol data units and a second observed delay of a second protocol data unit of the first plurality of protocol data units and a second difference between a first indication of the time to the next burst corresponding to the first protocol data unit of the first plurality of protocol data units and a second indication of the time to the next burst corresponding to the second protocol data unit of the first plurality of protocol data units.

Aspect 6: The method of any of aspects 3 through 5, further comprising: outputting the burst of the first plurality of protocol data units, wherein at least one protocol data unit of the first plurality of protocol data units that is output by the network entity comprises an updated indication of the time to the next burst of the second plurality of protocol data units based at least in part on the jitter associated with the network path.

Aspect 7: The method of any of aspects 1 through 6, wherein each protocol data unit of the first plurality of protocol data units comprises a real-time transport protocol (RTP) header that comprises the respective indication of the time to the next burst of the second plurality of protocol data units.

Aspect 8: The method of any of aspects 1 through 7, wherein the burst of the first plurality of protocol data units comprises a first one or more protocol data units from a first Protocol Data Unit Set and a second one or more protocol data units from a second Protocol Data Unit Set.

Aspect 9: The method of any of aspects 1 through 8, wherein the network entity is a User Plane Function (UPF).

Aspect 10: A network entity for wireless communications, comprising one or more memories storing processor-executable code, and one or more processors coupled with the one or more memories and individually or collectively operable to execute the code to cause the network entity to perform a method of any of aspects 1 through 9.

Aspect 11: A network entity for wireless communications, comprising at least one means for performing a method of any of aspects 1 through 9.

Aspect 12: A non-transitory computer-readable medium storing code for wireless communications, the code comprising instructions executable by one or more processors to perform a method of any of aspects 1 through 9.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
obtain one or more protocol data units of a burst of a first plurality of protocol data units, wherein each protocol data unit of the first plurality of protocol data units comprises a respective indication of a time to a next burst of a second plurality of protocol data units based at least in part on a departure time of a corresponding protocol data unit of the first plurality of protocol data units; and
monitor for a first protocol data unit of the next burst of the second plurality of protocol data units based at least in part on the time to the next burst of the second plurality of protocol data units.

2. The network entity of claim 1, wherein:
a first protocol data unit of the first plurality of protocol data units comprises a first indication of the time to the next burst of the second plurality of protocol data units; and
a second protocol data unit of the first plurality of protocol data units comprises a second indication of the time to the next burst of the second plurality of protocol data units based at least in part on the first indication of the time to the next burst and a difference in departure time between the first protocol data unit of the first plurality of protocol data units and the second protocol data unit of the first plurality of protocol data units.

3. The network entity of claim 1, wherein, to monitor for the first protocol data unit of the second plurality of protocol data units, the one or more processors are individually or collectively operable to execute the code to cause the network entity to:
monitor for the first protocol data unit of the next burst of the second plurality of protocol data units based at least in part on a jitter associated with a network path.

4. The network entity of claim 3, wherein the one or more processors are individually or collectively further operable to execute the code to cause the network entity to:
measure the jitter associated with the network path based at least in part on a comparison of an indicated difference in departure time between a first protocol data unit of the first plurality of protocol data units and a second protocol data unit of the first plurality of protocol data units and an observed difference in departure time between the first protocol data unit and the second protocol data unit.

5. The network entity of claim 3, wherein the one or more processors are individually or collectively further operable to execute the code to cause the network entity to:
measure the jitter associated with the network path based at least in part on a first difference between a first observed delay of a first protocol data unit of the first plurality of protocol data units and a second observed delay of a second protocol data unit of the first plurality of protocol data units and a second difference between a first indication of the time to the next burst corresponding to the first protocol data unit of the first plurality of protocol data units and a second indication of the time to the next burst corresponding to the second protocol data unit of the first plurality of protocol data units.

6. The network entity of claim 3, wherein the one or more processors are individually or collectively further operable to execute the code to cause the network entity to:
output the burst of the first plurality of protocol data units, wherein at least one protocol data unit of the first plurality of protocol data units that is output by the network entity comprises an updated indication of the time to the next burst of the second plurality of protocol data units based at least in part on the jitter associated with the network path.

7. The network entity of claim 1, wherein each protocol data unit of the first plurality of protocol data units comprises a real-time transport protocol (RTP) header that comprises the respective indication of the time to the next burst of the second plurality of protocol data units.

8. The network entity of claim 1, wherein the burst of the first plurality of protocol data units comprises a first one or more protocol data units from a first Protocol Data Unit Set and a second one or more protocol data units from a second Protocol Data Unit Set.

9. The network entity of claim 1, wherein the network entity is a User Plane Function (UPF).

10. A method for wireless communications at a network entity, comprising:
obtaining one or more protocol data units of a burst of a first plurality of protocol data units, wherein each protocol data unit of the first plurality of protocol data units comprises a respective indication of a time to a next burst of a second plurality of protocol data units based at least in part on a departure time of a corresponding protocol data unit of the first plurality of protocol data units; and
monitoring for a first protocol data unit of the next burst of the second plurality of protocol data units based at least in part on the time to the next burst of the second plurality of protocol data units.

11. The method of claim 10, wherein:
a first protocol data unit of the first plurality of protocol data units comprises a first indication of the time to the next burst of the second plurality of protocol data units; and
a second protocol data unit of the first plurality of protocol data units comprises a second indication of the time to the next burst of the second plurality of protocol data units based at least in part on the first indication of the time to the next burst and a difference in departure time between the first protocol data unit of the first plurality of protocol data units and the second protocol data unit of the first plurality of protocol data units.

12. The method of claim 10, wherein monitoring for the first protocol data unit of the second plurality of protocol data units comprises:
monitoring for the first protocol data unit of the next burst of the second plurality of protocol data units based at least in part on a jitter associated with a network path.

13. The method of claim 12, further comprising:
measuring the jitter associated with the network path based at least in part on a comparison of an indicated difference in departure time between a first protocol data unit of the first plurality of protocol data units and a second protocol data unit of the first plurality of protocol data units and an observed difference in departure time between the first protocol data unit and the second protocol data unit.

14. The method of claim 12, further comprising:
measuring the jitter associated with the network path based at least in part on a first difference between a first observed delay of a first protocol data unit of the first plurality of protocol data units and a second observed delay of a second protocol data unit of the first plurality of protocol data units and a second difference between a first indication of the time to the next burst corresponding to the first protocol data unit of the first plurality of protocol data units and a second indication of the time to the next burst corresponding to the second protocol data unit of the first plurality of protocol data units.

15. The method of claim 12, further comprising:
outputting the burst of the first plurality of protocol data units, wherein at least one protocol data unit of the first plurality of protocol data units that is output by the network entity comprises an updated indication of the time to the next burst of the second plurality of protocol data units based at least in part on the jitter associated with the network path.

16. The method of claim 10, wherein each protocol data unit of the first plurality of protocol data units comprises a real-time transport protocol (RTP) header that comprises the respective indication of the time to the next burst of the second plurality of protocol data units.

17. The method of claim 10, wherein the burst of the first plurality of protocol data units comprises a first one or more protocol data units from a first Protocol Data Unit Set and a second one or more protocol data units from a second Protocol Data Unit Set.

18. The method of claim 10, wherein the network entity is a User Plane Function (UPF).

19. A non-transitory computer-readable medium storing code for wireless communications, the code comprising instructions executable by one or more processors to:
obtain one or more protocol data units of a burst of a first plurality of protocol data units, wherein each protocol data unit of the first plurality of protocol data units comprises a respective indication of a time to a next burst of a second plurality of protocol data units based at least in part on a departure time of a corresponding protocol data unit of the first plurality of protocol data units; and
monitor for a first protocol data unit of the next burst of the second plurality of protocol data units based at least in part on the time to the next burst of the second plurality of protocol data units.

20. The non-transitory computer-readable medium of claim 19, wherein:
a first protocol data unit of the first plurality of protocol data units comprises a first indication of the time to the next burst of the second plurality of protocol data units; and
a second protocol data unit of the first plurality of protocol data units comprises a second indication of the time to the next burst of the second plurality of protocol data units based at least in part on the first indication of the time to the next burst and a difference in departure time between the first protocol data unit of the first plurality of protocol data units and the second protocol data unit of the first plurality of protocol data units.
